(19) United States
(12) Patent Application Publication
(10) Pub. No.: US 2015/0040730 A1
(43) Pub. Date: Feb. 12, 2015

(54) CLEVIS TOOL WITH SPLIT ENDS

(71) Applicant: Robert Shane Violett, Winter Springs, FL (US)

(72) Inventor: Robert Shane Violett, Winter Springs, FL (US)

(21) Appl. No.: 14/317,720

(22) Filed: Jun. 27, 2014

Related U.S. Application Data
(60) Provisional application No. 61/864,276, filed on Aug. 9, 2013.

(51) Int. Cl. B25B 7/22; B25B 27/14

(52) U.S. Cl. CPC B25B 7/22; B25B 27/14
USPC 81/419; 81/423

(57) ABSTRACT

A clevis tool has a first and second handle extending from a proximal end to a distal en, the first handle and the second handle being rotatably coupled to each other between respective proximal and distal ends. An engagement member is configured to be attached to the distal end of one of the first and second handles and a distal end having a opening extending from the distal end toward the proximal end to engage the prongs of a clevis fastener.

### REFERENCE TO RELATED CASE

This application claims priority under 35 U.S.C. §119 (e) to provisional application no. 61/864,276 filed on Aug. 9, 2013, which is hereby incorporated by reference in its entirety.

### BACKGROUND OF THE INVENTION

### Field of the Invention

The present invention relates to a tool that has been created that allows the user to engage the two prongs of a clevis fastener and spread the prongs of a clevis fastener sufficiently to allow the clevis pin to engage the receiving hole. A clevis fastener is generally a U-shaped piece (generally referred to as the clevis) with holes at the end of the prongs and a pin is inserted into the two holes to capture the connected piece. The pin may be free floating relative to the clevis, but the pin may also be attached to the end of one of the prongs of the clevis.

In the model airplane industry, which also includes unmanned aerial vehicles (UAVs), a hole is at the end of one the prongs and a pin is attached at the end of the other prong. The spring steel or plastic u-shaped clevis must be spread open sufficiently to allow the pin to engage a matching hole in a control horn. In the model airplane industry, a clevis fastener may be used to connect servo drive devices to aerodynamic control surfaces such as the ailerons, elevators, rudder, flaps, etc., and also to ground-steering devices such a steerable nose and tail wheels and power control devices. In a model car or boat, a clevis fastener is used to connect left and right steering components and power control devices. Many times the clevis fastener is used in tight quarters and hard to reach places.

With the pin being attached to one of the prongs of the clevis fastener, in order to open the clevis fastener to allow for insertion of the piece to be connected (the control horn, etc.) the two prongs must be spread wide enough to allow the unconnected prong to be moved beyond the pin attached to the other prong to provide an opening into the clevis fastener. This opening must be sufficient to allow the pin to engage a receiving hole in the control horn, servo drive arm, steering linkage, etc. These receiving members may also be referred to as “tangs.”

Thus, the present invention is a clevis tool that has a pair of handles attached to a pair of jaws, wherein operating the handles causes the jaws to move outward or inward relative to one another. The basic principle of operation may be that of a simple pair of pliers or that of more complicated snap-ring pliers that allow the operator to change how the jaws move relative to the operation of the handles

### SUMMARY OF THE INVENTION

The present invention is directed to a clevis tool that includes a first handle extending from a proximal end to a distal end, a second handle extending from a proximal end to a distal end, the first handle and the second handle being rotatably coupled to each other between respective proximal and distal ends, an engagement member attached to the distal end of each of the first and second handles, the engagement member having a proximal end configured to be attached to the distal end of one of the first and second handles and a distal end having a opening extending from the distal end toward the proximal end.

In some embodiments, the engagement member has a cross section, the cross section at the proximal end being different from the distal end.

In some embodiments, the proximal end of the engagement member lies along a first axis and the distal end of the engagement member lies along a second axis, the first and second axis intersecting at a point and forming an angle.

In some embodiments, the distal end of the engagement members have two surfaces extending from the distal end toward the proximal end and defining the opening therein, the two surfaces having a chamfer adjacent the distal end causing the opening to be wider at the distal end of the engagement member.

In yet another aspect, the present invention is directed to an engagement member to be inserted into a distal end of one of a first and second handle of a clevis tool, the engagement member that includes a proximal end configured to be attached to the distal end of one of the first and second handles, the proximal end being an elongated member, and a distal end having a opening extending from the distal end toward the proximal end, the opening sized to receive a prong from a clevis therein, wherein the proximal end of the engagement member lies along a first axis and the distal end of the engagement member lies along a second axis, the first and second axis intersecting at a point and forming an angle.

Additional features and advantages of the invention will be set forth in the detailed description which follows, and in part will be readily apparent to those skilled in the art from that description or recognized by practicing the invention as described herein, including the detailed description which follows, the claims, as well as the appended drawings.

It is to be understood that both the foregoing general description and the following detailed description of the present embodiments of the invention, and are intended to provide an overview or framework for understanding the nature and character of the invention as it is claimed. The accompanying drawings are included to provide a further understanding of the invention, and are incorporated into and constitute a part of this specification. The drawings illustrate various embodiments of the invention, and together with the description serve to explain the principles and operations of the invention.

### BRIEF DESCRIPTION OF THE DRAWINGS

FIG. 1 illustrates a control rod with a clevis fastener on each end connected to a servo arm on one end and a control horn on the other;

FIG. 2 is a top perspective view of a portion of one embodiment of a clevis tool with an additional engagement member according to the present invention;

FIG. 3 is top view of the clevis tool of FIG. 2;

FIG. 3A is an enlarged view of the ends of the engagement member;

FIG. 4 is a perspective view of the clevis tool of FIG. 2 engaging a clevis fastener;

FIG. 5 is rear side view of the clevis tool of FIG. 2;

FIG. 6 is a side perspective view of the clevis tool of FIG. 2;

FIG. 7 is a partial view of the clevis tool of FIG. 2 engaging a clevis fastener in a flap control horn inside a wing of a model airplane;

FIG. 8 is a partial view of the clevis tool of FIG. 2 using the inside surfaces of the engagement members to reconnect the clevis fastener; and

FIG. 9 a partial view of the clevis tool of FIG. 2 engaging a clevis fastener attached to a wing aileron control horn in a tight area.

### DETAILED DESCRIPTION OF THE PREFERRED EMBODIMENTS

Reference will now be made in detail to the present preferred embodiment(s) of the invention, examples of which are illustrated in the accompanying drawings. Whenever possible, the same reference numerals will be used throughout the drawings to refer to the same or like parts.

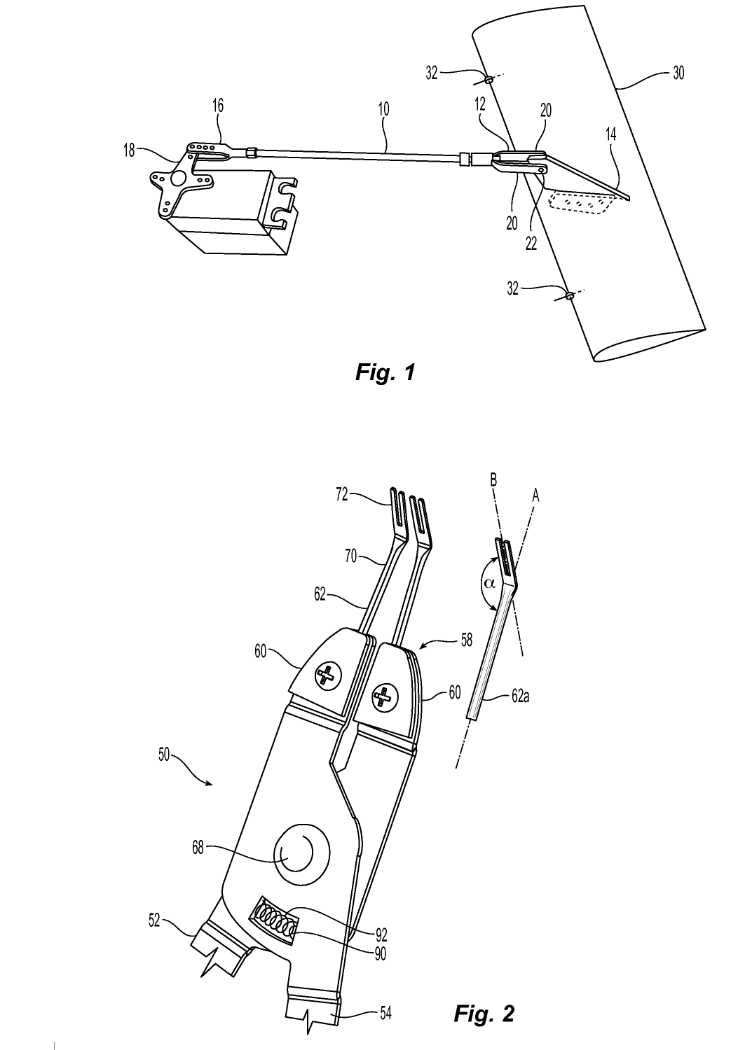

FIG. 1 illustrates a control rod 10 with a clevis fastener 12 on one end, which is attached to a control tang (horn) 14. The control tang 14 is illustrated as being attached to a control surface 30. The control surface 30 may be an aileron on a model plane that rotates about pivot points 32. Or the control surface 30 may any number of structures in a model airplane. The control rod 10 is also has a clevis fastener 16 on the other end, which is attached to a servo arm 18. The clevis fasteners 12,16, as noted above, are a u-shaped piece with two prongs 20 and an opening 22 in the end with a pin 24. See FIG. 4. To attach the clevis fastener 12 to a connected piece (the control tang (horn) 14 or the servo arm 18), the prongs 20 must be spread apart to remove the pin 24 from the opening 22 in the prong 20. The pin 24 is typically attached to one of the prongs 20, to avoid the pin 24 from falling out during connection or operation. It is the opening (and then the closing) of the clevis fasteners that the present invention is directed to.

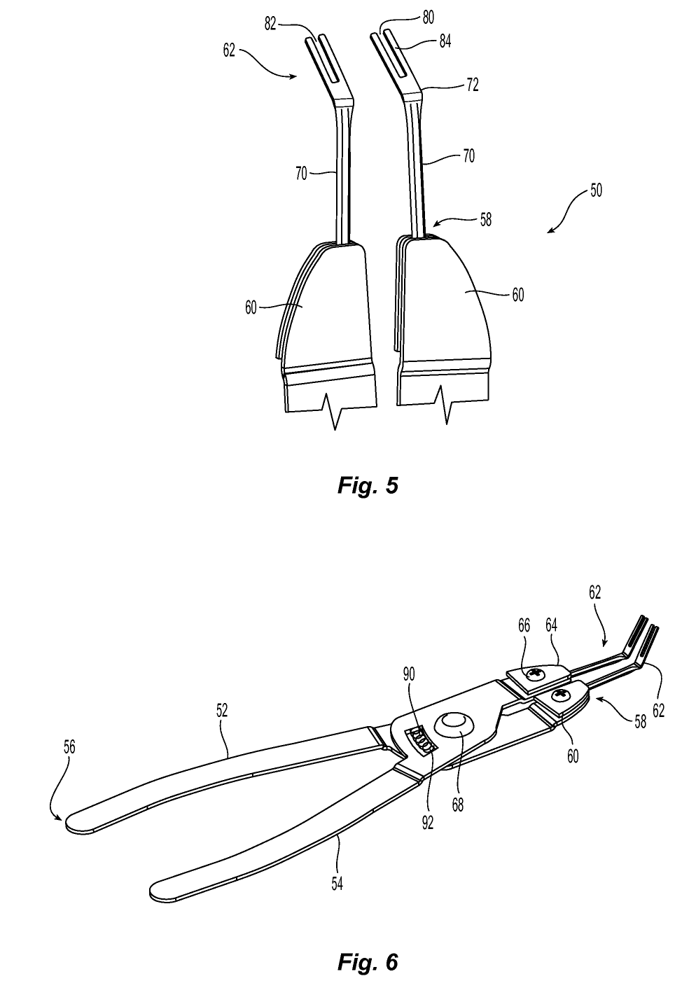

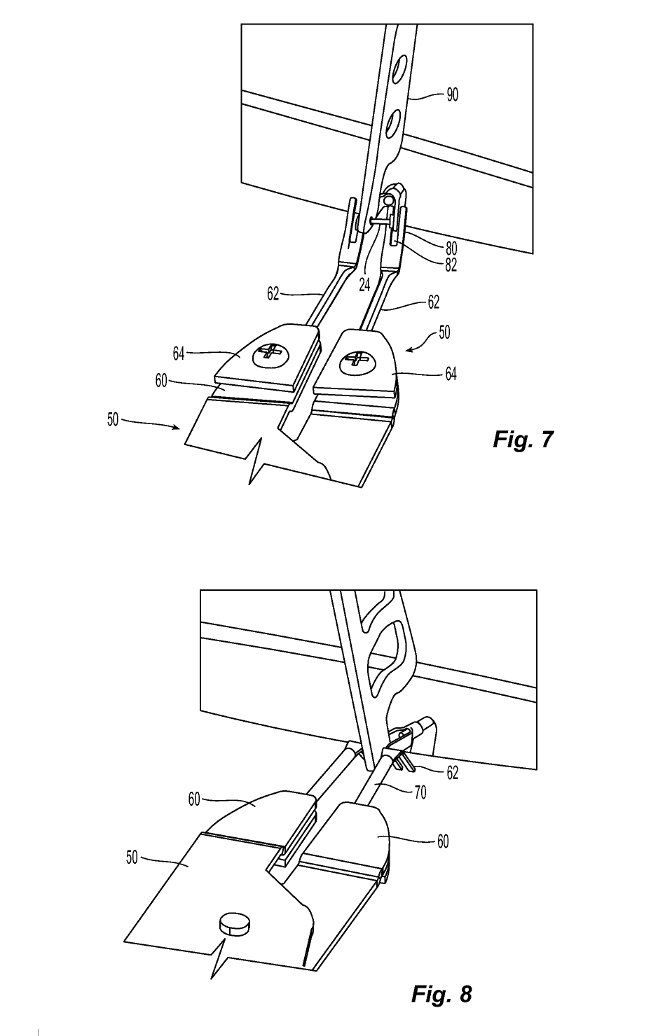

Turning to FIGS. 2-6, one embodiment of a clevis tool 50 is illustrated. The clevis tool 50 has two handles 52,54 that extend between a proximal end 56 and a distal end 58. The distal end 58 has, as with normal pliers, jaws 60. Instead of the jaws 60 engaging the clevis fastener 16, engagement members 62 are attached to the distal ends 58 or jaws 60 of the handles 52,54. The handles 52,54 rotate relative to one another about point 68, which is a fastener that allows the handles 52,54 move without coming apart. The clevis tool 50 may also include an opening 90 that further includes a spring 92 to bias the jaws 60 toward one another. The distal ends 58 or jaws 60 are constructed to allow the engagement members 62 to be attached thereto. As illustrated, the distal ends 58 or jaws 60 have a plate 64 that is attached by a screw 66 to the distal ends 58 or jaws 60 and the engagement members 62 are secured between the distal ends 58 or jaws 60 and the plate 64. Other constructions at the the distal ends 58 or jaws 60 is possible and still come within the scope of the present invention. For example, there could be a channel or other opening into a solid end of the the distal ends 58 or jaws 60, and then use a set screw to secure the engagement members 62 therein.

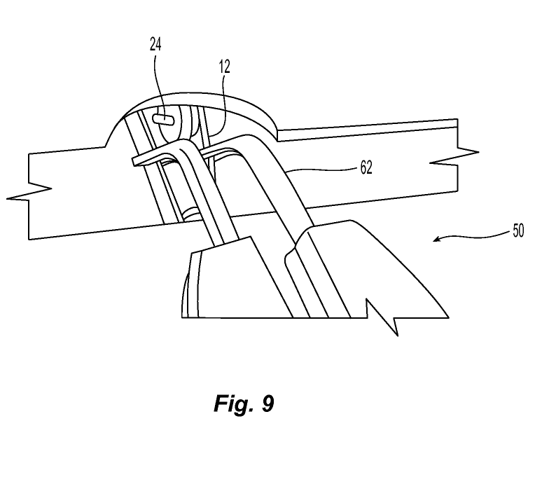

The engagement members 62 have a proximal end 70 and a distal end 72. The proximal end 70 is attached to the distal ends 58 or jaws 60 of the clevis tool 50. The proximal end 70 has a cross section that can be of any appropriate configuration, but is illustrated in FIG. 2 in two different configurations. The engagement members 62 have a hexagonal cross section to increase the contact surface between the distal ends 58 or jaws 60 and the plate 64. However, as also illustrated in FIG. 2, the engagement member 62a has a circular cross section. As is also illustrated in FIG. 2, the engagements members 62 (and 62a) preferably have a angle introduced between the proximal end 70 and the distal end 72. The proximal end 70 lies in an axis A, while the distal end 72 lies in the axis B, the axes forming an angle ∝. While the proximal end 70 and the distal end 72 are illustrated as having a relatively sharp bend to achieve the angle ∝, it should be noted that the angle ∝ could be formed through a more gradual bend to achieve that angle. The angle ∝ is preferably between about 80 and 170 degrees and more preferably between about 125 and 150 degrees. The angle ∝ used may also depend on the areas where the clevis tool 50 will be used. For example, in some instances, the angle may need to be greater (approaching a straight engagement member 62) to reach farther, or smaller to reach into more restricted areas. See, e.g., FIG. 9. The angle ∝ is measured such that the angle can vary between ∝ and 180 degrees. Thus, if, as illustrated in FIG. 2, the distal end 72 rotated further such that the angle ∝ becomes more than 180, then the angle should be measured from the other side of the engagement member 62, so that the angle varies between 0 and 180 degrees.

The lengths of the engagement members 62 is not critical to the operation of the clevis tool 50. Additionally, the relative lengths of the proximal end 70 and the distal end 72 is similarly not critical. Thus, either the proximal end 70 and the distal end 72 may be shorter or longer.

The distal end 72 of the engagement member 62 has two tines 80 that form an opening 82 between them. The opening 82 is illustrated as extending substantially the entire length of the distal end 72. Again, the length of the opening 82 relative to the distal end 72 of the engagement member 62 may depend on the use of the clevis tool 50 and the actual length of the engagement member 62. For example, if the length of distal end 72 is longer than that illustrated in the figures. then the opening will extend the length of the distal end 72. However, the opening 82 needs to have a sufficient length to avoid the prongs 20 from prematurely disengaging the clevis tool 50.

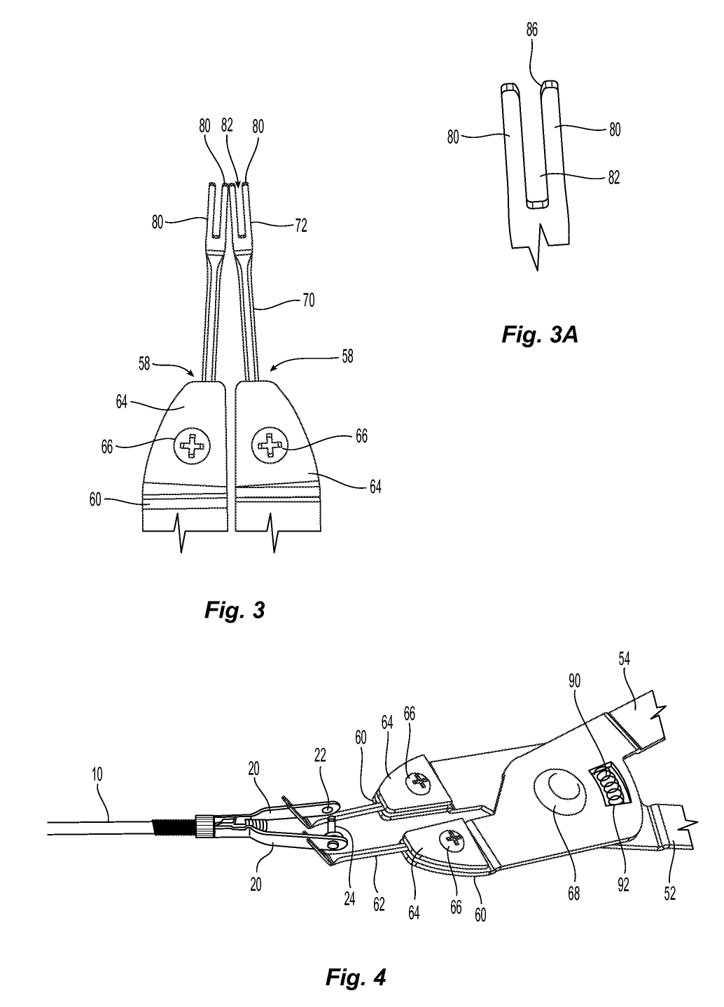

The distal end 72 or tines 80 have two interior surfaces 84 that form the opening 82. The distal end of the tines 80 have a chamfer 86 allow the clevis fastener 12 to enter the opening 82 more easily. Thus the opening 82 is wider at the at the chamfer 86 than more proximally, toward the proximal end 70. See FIG. 3A.

Illustrated in FIG. 4 is the clevis tool 50 engaging a clevis fastener 12. Each of the prongs 20 are disposed in a respective opening 82 of the clevis tool 50. Opening the handles 52,54 causes the engagement members 62 to move apart. This in turn causes the prongs 20 to separate and the pin 24 to be removed from the opening 22. The clevis fastener 12 can now be attached or removed from a connecting piece. See also FIG. 7, where the pin 24 is being removed from engaging a flap control horn 90 in an internal portion of a wing.

The clevis tool 50 can also be used to secure a clevis fastener 12 to a connecting piece. As illustrated in FIG. 8, inside portions of the engagement members 62 can be used to push the prongs 20 of the clevis fastener 12 together, securing the pin (not visible in FIG. 8) into the opening 22 of the clevis fastener 12 by closing the handles 52,54. Naturally, the prongs 20 can also be disposed in the openings 82 of the engagement members 62 to close the clevis fastener 12.

Similarly, the clevis tool 50 is illustrated in FIG. 9 in a tighter area to access a clevis fastener 12. The clevis tool 50 has opened the clevis fastener 12 and the pin 24 is visible. The clevis tool 50 allows for easy opening and closing of the clevis fastener 12 is areas that before were very difficult to access.

It will be apparent to those skilled in the art that various modifications and variations can be made to the present invention without departing from the spirit and scope of the invention. Thus it is intended that the present invention cover the modifications and variations of this invention provided they come within the scope of the appended claims and their equivalents.

I claim:

1. A clevis tool comprising:
a first handle extending from a proximal end to a distal end;
a second handle extending from a proximal end to a distal end, the first handle and the second handle being rotatably coupled to each other between respective proximal and distal ends;
an engagement member attached to the distal end of each of the first and second handles, the engagement member having a proximal end configured to be attached to the distal end of one of the first and second handles and a distal end having a opening extending from the distal end toward the proximal end.

2. The clevis tool according to claim 1, wherein the opening is a slot.

3. The clevis tool according to claim 1, wherein the engagement member has a cross section, the cross section at the proximal end being different from the distal end.

4. The clevis tool according to claim 1, wherein the proximal end of the engagement member lies along a first axis and the distal end of the engagement member lies along a second axis, the first and second axis intersecting at a point and forming an angle.

5. The clevis tool according to claim 4, wherein the angle is between about 80 and 170 degrees.

6. The clevis tool according to claim 4, wherein the angle is between about 125 and 150 degrees.

7. The clevis tool according to claim 1, wherein the distal end of the engagement members have two surfaces extending from the distal end toward the proximal end and defining the opening therein, the two surfaces having a chamfer adjacent the distal end causing the opening to be wider at the distal end of the engagement member.

8. The clevis tool according to claim 1, wherein the opening has a substantially constant width.

9. The clevis tool according to claim 1, wherein the engagement members are removably attached to the distal end of the handles.

10. An engagement member to be inserted into a distal end of one of a first and second handle of a clevis tool, the engagement member comprising:
a proximal end configured to be attached to the distal end of one of the first and second handles, the proximal end being an elongated member; and
a distal end having a opening extending from the distal end toward the proximal end, the opening sized to receive a prong from a clevis therein,
wherein the proximal end of the engagement member lies along a first axis and the distal end of the engagement member lies along a second axis, the first and second axis intersecting at a point and forming an angle.

11. The engagement member according to claim 10, wherein the opening is a slot.

12. The engagement member according to claim 10, wherein the angle is between about 110 and 170 degrees.

13. The engagement member according to claim 10, wherein the angle is between about 125 and 150 degrees.

14. The engagement member according to claim 10, wherein the distal end of the engagement members have two surfaces extending from the distal end toward the proximal end and defining the opening therein, the two surfaces having a chamfer adjacent the distal end causing the opening to be wider at the distal end of the engagement member.

15. The engagement member according to claim 10, wherein the engagement member has a cross section, the cross section at the proximal end being different from the distal end.
